(19) United States
(12) Patent Application Publication
(10) Pub. No.: US 2019/0084070 A1
(43) Pub. Date: Mar. 21, 2019

(54) MIG WELDING SYSTEM

(71) Applicants: CHANGWON NATIONAL UNIVERSITY Industry Academy Cooperation Corps, Changwon-si, Gyeongsangnam-do (KR); BEST F.A CO., LTD., Changwon-si, Gyeongsangnam-do (KR)

(72) Inventors: Young Tae CHO, Daejeon (KR); Chang Je LEE, Changwon-si (KR); Yoon Gyo JUNG, Changnyeong-gun (KR); Young Cheol JEONG, Changwon-si (KR)

(73) Assignees: CHANGWON NATIONAL UNIVERSITY Industry Academy Cooperation Corps, Changwon-si, Gyeongsangnam-do (KR); BEST F.A CO., LTD., Changwon-si, Gyeongsangnam-do (KR)

(21) Appl. No.: 15/760,682

(22) PCT Filed: Apr. 29, 2016
(86) PCT No.: PCT/KR2016/004505

§ 371 Date: Mar. 16, 2018

(30) Foreign Application Priority Data
Sep. 16, 2015 (KR) 10-2015-0130861

(51) Int. Cl. B23K 9/095; B23K 9/173; G01J 5/48

(52) U.S. Cl. CPC B23K 9/0956; G01J 5/48; B23K 9/173

(57) ABSTRACT

The present invention relates to a MIG welding system including: operating a vision module and a welding device; capturing a thermal image of a welding part using an IR thermal camera connected to the vision module, converting the image into a video signal, and transmitting the video image to the vision module; detecting whether there is slag through the vision module; determining whether the detected slag is fixed when the slag is detected through the vision module; and analyzing the position of the slag and calculating a coordinate value when it is determined that the detected slag is fixed. Even if the slag is not checked with the naked eye, the operator can determine the position of the fixed slag which is not checked with the naked eye through the calculated coordinate values.

### FIELD

The present invention relates to a MIG welding system, and more particularly, to a MIG welding system capable of efficiently checking a position of a fixed type slag.

### BACKGROUND

Generally, arc welding is one of welding methods for generating an electric arc and melting a base material using the electric arc as a heat source to perform welding, and the types thereof are very diverse.

Among various arc welding methods, an inert gas arc welding is a method for performing welding, while supplying the inert gas to the welding part from a torch. In order to weld a special welding part in a state of being isolated from the air. Here, argon, helium, or the like is used as the inert gas, and a tungsten rod or a metal rod is used as an electrode.

Such an inert gas arc welding method is also referred to as a shield arc welding, and is classified into two types of a method using a heat source of a tungsten arc in an inert gas atmosphere and a method using a heat source of a metal arc. That is, there are a non-consumable type which is not melted and a consumable type which is melt depending on the electrode used as a heat source.

Here, since the non-consumable type uses a tungsten electrode rod, the non-consumable type is called a shielded inert gas tungsten arc welding or a TIG welding method. Further, since the consumable type uses a long core wire filler metal, the consumable type is called an inert gas arc welding method or a MIG welding method.

On the other hand, since welding using pure Ar gas as a shield gas hardly produces oxides such as slag and fume in principle, it is possible to expect an improvement effect against defective coating properties caused by adhesion of slag or bad influence on human body due to suction of fume.

In this way, the pure Ar gas welding is useful from many viewpoints such as nonuse of greenhouse gases, precious metal saving, improvement in appearance of welding part, and improvement in sanitation environment of welding field.

At this time, pure Ar gas can be used in the TIG welding method which uses tungsten which is a non-consumable electrode as the electrode and melts the welding rod by arc heat generated between the electrode and the base metal. However, compared to the MIG welding method which generates an arc from the wire itself, since there is no resistance heating effect, there is a disadvantage that it is extremely inefficient.

Also, in the case of the MIG welding method, although there is an advantage that the efficiency is higher than that of the TIG welding method, since the oxide such as slag and fume is necessarily generated in the welding process, defective coating properties caused by slag adhesion becomes a serious problem.

FIG. 1 is a conceptual view schematically illustrating a typical MIG welding device, and FIG. 2 is a partial cutaway sectional view illustrating a torch leading end portion in a general MIG welding device in an enlarged manner.

Referring to FIGS. 1 and 2, a typical MIG welding device includes a torch 30, a wire feeder 20, a power supply device 10 and the like.

One electrode of the power supply device 10 is connected to a base material M by a welding cable, and the other electrode is connected to a welding tip 32 provided at a leading end of the torch 30 to apply electricity to a wire 25 passing through the center of the welding tip 32. At this time, the wire 25 functions not only as a filler in the welding circuit but also as an electrode forming a welding circuit. That is, the torch 30 may generate an arc between the base material M and the wire 25 by applying electricity to the wire 25, while using an inert gas as a protective gas. At this time, the wire 25 made of the same material as the base material M is alloyed, while filling the melted part, thereby performing welding.

Further, the wire 25 is continuously supplied to the interior of the torch 30 by a wire feeder 20 including a wire spool 21, a feed motor, a roller and the like. A nozzle 31 is formed at the leading end of the torch 30, the welding tip 32 is built at the center of the nozzle 31, and the wire 25 is transferred to the center of the welding tip 32.

There are advantages that the above-mentioned MIG welding can be applied to most metals, welding can be performed in a wide range, and an appearance of a clean bead can be obtained as compared to other welding methods. Thus, the MIG welding is constantly used in industrial fields having the constant working condition and requiring large amounts of continuous welding, such as a vehicle body panel and a ship.

On the other hand, as described above, the bead-like fixed type non-metallic slag containing components such as FeO, SiO₂, and MnO generated during the welding process becomes a factor that hinders the automation of welding. Although the above-described MIG welding has a smaller incidence of slag compared to other welding methods, the reason is that the fixed type slag generated once is classified as a defect, and after it is visually checked by an operator in the subsequent treatment process, the fixed type slag needs to be manually removed.

Further, in the case of fixed type slag, although it may be visually checked by an operator, in some cases, it may not be visually checked by the operator. When the operators perform a work of removing the fixed type slag, since determination is unclear, there may be a difficulty in efficient removal.

### SUMMARY

Aspects of the present invention provide a MIG welding system capable of efficiently checking the position of a fixed type slag to which slag generated during a welding process is fixed.

The aspects of the present invention are not limited to the aforementioned aspects, and another aspect which has not been mentioned may be clearly understood by those skilled in the art from the description below.

In order to solve the aforementioned problems, according to an aspect of the present invention, there is provided a MIG welding system including: operating a vision module and a welding device; capturing a thermal image of a welding part using an IR thermal camera connected to the vision module, converting the image into a video signal, and transmitting the video image to the vision module; detecting whether there is slag through the vision module; determining whether the detected slag is fixed when the slag is detected through the vision module; and analyzing the position of the slag and calculating a coordinate value when it is determined that the detected slag is fixed.

Further, the present invention provides the MIG welding system which includes a base material (M) in which welding progresses, wherein the base material (M) includes a low-temperature region in which solidification of the molten pool progresses; and a high-temperature region which is located adjacent to the low-temperature region and in a state of a molten pool.

Further, the present invention provides the MIG welding system in which determining whether the detected slag is fixed includes defining a low-temperature region lower than the high-temperature region by a constant temperature; and determining whether a spaced interval between the low-temperature region and the slag is equal to or less than a constant interval.

Further, the present invention provides the MIG welding system in which, when the slag is not detected, the welding part is continuously captured through the IR thermal camera and a video signal is transmitted to the vision module.

Further, the present invention provides the MIG welding system in which, in a case where the slag is not fixed, the welding part is continuously captured through the IR thermal camera and the video signal is transmitted to the vision module.

According to the present invention as described above, when the slag is generated, a low-temperature region having a temperature lower than the high-temperature region is defined, and thereafter, whether the spaced interval between the low-temperature region and the slag is equal to or less than a predetermined interval is determined.

Thus, when the interval between the low-temperature region and the slag is equal to or less than the predetermined interval, it is possible to determine that the generated slag is fixed at that position.

Therefore, in the present invention, even when the fixed slag is not visually checked, the operator can check the position of the fixed slag which is not visually checked, through the calculated coordinate value.

### BRIEF DESCRIPTION OF THE DRAWINGS

The above and other aspects and features of the present invention will become more apparent by describing in detail exemplary embodiments thereof with reference to the attached drawings, in which:

FIG. 1 is a conceptual diagram schematically illustrating a typical MIG welding device;

FIG. 2 is an enlarged partial cross-sectional view illustrating a torch leading end portion in a typical MIG welding device;

FIG. 3 is a schematic diagram illustrating a MIG welding system according to the present invention;

FIG. 4 is a block diagram illustrating a configuration of a vision module 150 according to the present invention;

FIG. 5 is an enlarged partial cross-sectional view illustrating a torch leading end portion in the MIG welding system according to the present invention;

FIG. 6 is a flowchart for explaining a method for checking a position of the fixed type slag via an IR thermal camera; and

FIGS. 7 and 8 are schematic diagrams for explaining whether or not the slag is fixed in the MIG welding system according to the present invention.

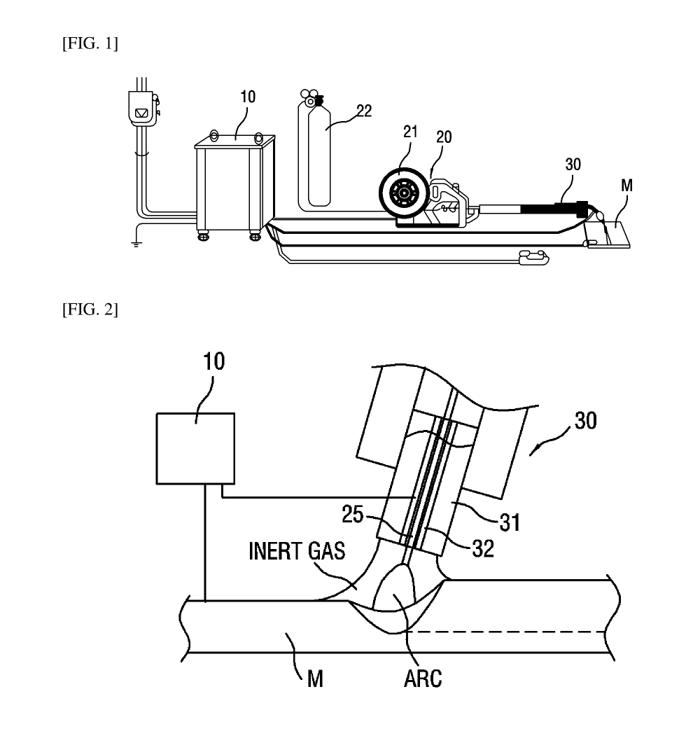

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Specific contents for carrying out the present invention will be described in detail with reference to the accompanying drawings. Regardless of the drawings, the same reference numerals refer to the same elements, and the term “and/or” includes each of the mentioned items and one or more combinations.

Although the terms “first, second, and the like” are used to describe various constituent elements, these constituent elements are, of course, not limited by these terms. These terms are merely used to distinguish one constituent element from other constituent elements. Therefore, it is a matter of course that the first constituent element described below may be a second constituent element within the technical idea of the present invention.

The terms used in the present specification are for the purpose of illustrating the examples and do not limit the present invention. As used herein, the singular form also includes the plural forms unless specifically stated in a phrase. The terns “comprises” and/or “comprising” used in the specification do not exclude the presence or addition of one or more other constituent elements in addition to the referenced constituent elements.

Unless otherwise defined, all terms (including technical and scientific terms) used in this specification may be used in the meaning that can be understood in common by those having ordinary skill in the technical field to which the present utility model belongs. Also, commonly used predefined terms are not interpreted ideally or unduly unless expressly defined otherwise.

Spatially relative terms “below”, “beneath”, “lower”, “above”, “upper” and the like may be used to easily describe the correlation between one constituent element and another constituent element as illustrated in the drawings. Spatially relative terms should be understood as terms including different directions of constituent elements during use or operation in addition to the directions illustrated in the drawings. For example, when reversing the constituent elements illustrated in the drawings, the constituent elements described as “below” or “beneath” of another constituent element may be placed “above” another constituent element. Thus, the exemplary term “below” may include both downward and upward directions. The constituent elements may also be oriented in other directions, and thus, the spatially relative terms can be interpreted by orientation.

Hereinafter, preferred embodiments of the present invention will be described in detail with reference to the attached drawings.

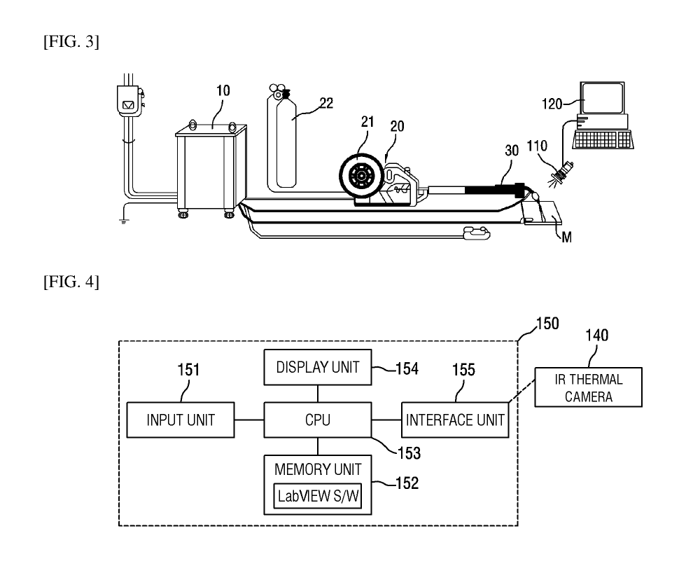

FIG. 3 is a schematic diagram illustrating a MIG welding system according to the present invention.

Referring to FIG. 3, the MIG welding system 100 according to the present invention includes a welding power source 110 equipped with a power source circuit; a wire feeder 120 connected to the welding power source to supply a wire 125; a torch 130 which pulls the wire 125 supplied from the wire feeder and supplies the wire 125 to the welding part; an IR thermal camera 140 which photographs the welding part; and a vision module 150 which incorporates a program for receiving and processing a captured image of the IR thermal camera.

At this time, in the embodiment of the present invention, in order to read the slag which is a welding defect, the fact that the infrared energy emitted from the nonmetallic fixed type slag generated at the time of welding is lower than that of the metal molten pool is utilized. That is, when the welding part is captured via the IR thermal camera 140, since the infrared energy is differently generated depending on the physical property value of the welding part, and the generated nonmetallic fixed type slag has lower temperature than the peripheral melting pool, it is possible to detect whether or not slag is generated from the isothermal line of the temperature data.

Subsequently, the IR thermal camera 140 transmits an image captured by detecting the infrared temperature of the welding part to the vision module 150. At this time, the vision module 150 reads the presence or absence of slag and the position coordinate value on the basis of the acquired video signal.

At this time, as the vision module 150, a machine vision system is applied which can combine video technologies, measure three-dimensional physical quantities, and apply them to automation. In general, a well-known machine vision system is a technique which images a product with a visible ray camera, transfers it to a computer instead of an inaccurate person's eye at an industrial site, and analyzes it with vision software to visually distinguish defects of products.

However, in the conventional machine vision system, collection and analysis of image data, defect reading, and the like are limited to products for which processes such as welding have been completed, and even if the system is applied to a MIG welding device, it is only used for reading and selecting defects such as slag generated in the welding process, and there is still a problem in which if the welding part is completely cooled down, removal of the already fixed slag should be carried out individually through subsequent operation.

On the other hand, in the vision module 150 applied to the welding device of the present invention, by receiving and analyzing the image obtained by continuously imaging the welding process using the IR thermal camera 140 in real time from the start to the end point of welding, it is possible to immediately detect slag generated during welding process.

To this end, the vision module 150 is based on a control PC with a built-in program, acquires the image captured by the IR thermal camera 140 by the built-in program to perform the vision processing thereof, and detects the presence or absence and position of slag of the welding part accordingly.

At this time, the program built in the vision module 150 may include LabVIEW which is a graphical programming language to receive and analyze captured images of the IR thermal camera 140.

The LabVIEW program is a control measurement language manufactured by National Instruments Inc. It can be configured to view actual device on a computer and is also called a virtual instrument. Further, since it is programmed to make diagram unlike text-based programming languages such as basic or C-language, it is also called graphics programming language.

In the above-described LabVIEW program, the order of programming progression includes various functions so as to control various devices according to the flow of data and process the data sent from the devices. Therefore, it is possible to easily provide the vision process and the automatic control of the automated facility by detecting the determination of defects caused by slag generation in the welding process in real time.

However, in the present invention, the program of the vision module 150 is not limited to LabVIEW S/W.

Subsequently, the vision module 150 may execute vision processing for images captured by the IR thermal camera 140 via a LabVIEW program, and it is configured on the basis of PC so that algorithms defined by operators are saved to control these series of operations by automation.

Therefore, before starting the welding process, the operator activates the vision module 150 to execute the LabVIEW program, inputs the operator's command and data to the vision module by the LabVIEW program, and may automatically perform monitoring of the welding part and slag removal in accordance with the defined algorithm.

FIG. 4 is a block diagram illustrating the configuration of the vision module according to the present invention.

Referring to FIG. 4, the vision module 150 according to the embodiment of the present invention may include an input unit 151 for inputting operator's instructions and data on the basis of a PC incorporating a LabVIEW program; a memory unit 152 which performs LabVIEW programming of an automation control algorithm created by the input unit and stores the automation control algorithm; a CPU 153 which receives a video signal captured by the IR thermal camera 140 and executes a vision process by a defined algorithm; a display unit 154 which visually checks the process of creating and executing an automation control algorithm using the LabVIEW program; and an interface unit 155 which is connected to the IR thermal camera 140 to transmit a video signal and a control signal.

At this time, the LabVIEW program may be configured to include an automation control algorithm that acquires the video signal received from the IR thermal camera 140 and detects whether a slag occurs and reads the slag occurrence position.

Hereinafter, the configuration and operation of the MIG welding system according to the present invention will be more specifically described.

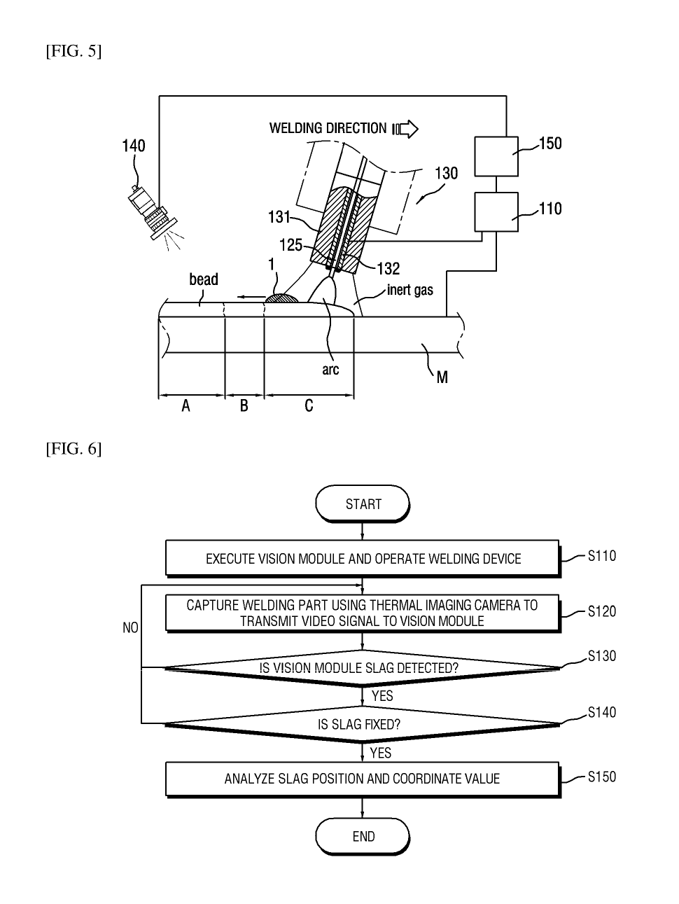

FIG. 5 is an enlarged partial cross-sectional view illustrating the torch leading end portion in the MIG welding system according to the present invention.

Referring to FIGS. 3 and 5, in a welding device 100 constructed in accordance with the present invention, electrical contact with a wire 125 occurs at the end portion of the welding tip 132, and the welding is performed, while the wire is consumed at the welding part through the heat received from arc and the heat received while energizing the current from the welding tip 132 to the leading end portion melted.

The torch 130 plays a role of applying electricity to the wire 125, while using an inert gas as a protective gas, and the torch 130 is connected to the gas container 122 to eject an inert gas such as helium or argon gas.

In the front inside of the torch 130, the wire 125 is provided to penetrate at the center of the torch 130, a welding tip 132 is covered on the outside of the wire 125, and a nozzle 131 is covered on the outside of the welding tip 132. The wire 125 is also provided to penetrate at the center in the rear inside of the torch 130, and the nozzle 131 is covered on the outside of the wire 125.

Further, a wire feeder 120 is installed behind the torch 130 so that the wire 125 can be continuously supplied to the interior of the torch 130. In the wire feeder 120, the wire 125 is wound around the wire spool 121, and the wire 125 is supplied to the torch 130 by pushing or pulling the wire 125 using a roller (not shown) driven by a feed motor (not shown). At this time, the wire feeder 120 may selectively apply one of a push type, a pull type or a push-pull type depending on the feeding method.

A welding power supply 110 is connected to the welding tip 132 and the base material M to apply electricity to the wire 125. That is, one electrode of the welding power source 110 is connected to the base material M, and the other electrode of the welding power source 110 is connected to the welding tip 132.

Further, the IR thermal camera 140 can be located to be spaced apart from the welding part of the base material M at a certain interval. At this time, the IR thermal camera 140 and the welding power supply 110 are connected to the interface unit of the vision module 150, respectively, receive and transmit electric signals, and are controlled by the vision module.

Next, a process in which the IR thermal camera 140 is controlled by the vision module 150 in the welding device of the present invention will be described.

FIG. 6 is a flowchart for explaining a method for checking the position of the fixed type slug via the IR thermal camera.

Referring to FIG. 6, in the process of checking the position of the fixed slag of the welding part via the IR thermal camera, first, prior to the operation of the welding device, after the LabVIEW program of the vision module 150 is executed, the welding device is operated (S110).

Next, the IR thermal camera 140 connected to the infrared vision module captures the thermal image of the welding part in real time, converts the image into a video signal which can be processed by the PC, and transmits the video signal to the vision module (S120).

Next, the vision module 150 executes the vision processing on the basis of the received video signal in accordance with a predetermined automation algorithm to detect whether or not slag is generated (S130).

At this time, the vision processing analyzes the video signal captured from the IR thermal camera 140 by the predefined LabVIEW program of the vision module, and detects whether or not slag as a defect of the welding part occurs. Meanwhile, the process of creating and executing the automation control algorithm using the LabVIEW program can be visually checked via the display unit 154 of the vision module, and when the occurrence of slag is detected by the vision processing, this can also be checked through the display unit.

In addition, the IR thermal camera continues to photograph the entire processes of the welding situation of the welding part, and transmits the image to the vision module, and the vision module continues to process the video signal received from the camera in real time, and detects the occurrence of slag.

Next, when a slag is detected through the above vision module, it is determined whether or not the detected slag is fixed (S140).

On the other hand, if no slug is detected, the welding part is continuously captured using the thermal image camera and the video signal is transmitted to the vision module (S120).

Whether or not the detected slag is fixed is determined as follows.

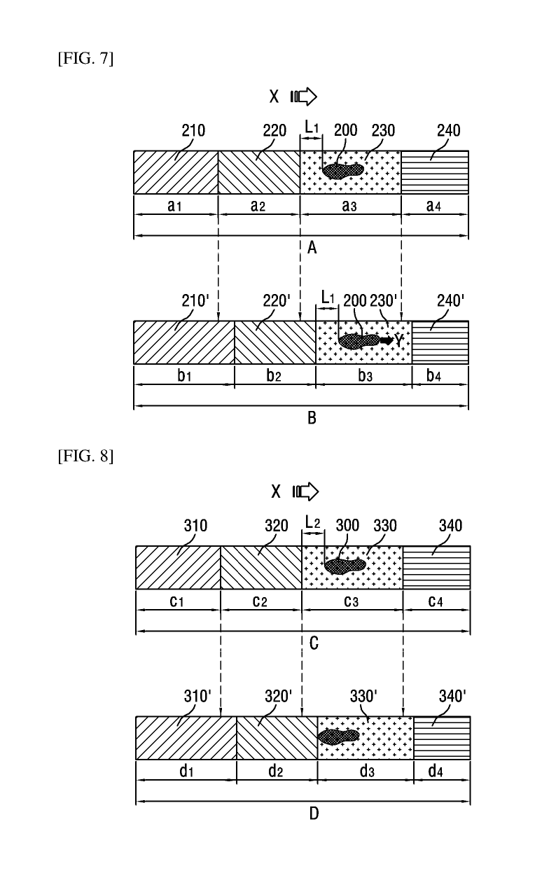

FIGS. 7 and 8 are schematic diagrams for explaining whether or not the slag is fixed in the MIG welding system according to the present invention. At this time, in the case of FIG. 7, a case where slag is not fixed and moves along the molten pool is illustrated, and in the case of FIG. 8, a case where slag is fixed is illustrated.

Referring to FIGS. 7 and 8, a region A of the base metal M during welding can be defined as follows.

First, the welding progress direction is an X direction, and the region A of the base material M includes a bead region 210 in which the welding is completed and the molten pool is completely solidified, a low-temperature region 220 which is located adjacent to the bead region and in which solidification of the molten pool proceeds, a high-temperature region 230 which is located adjacent to the low-temperature region 220 and is in the state of the molten pool, and a welding non-progress region 240 which is located adjacent to the high-temperature region 230 and in which welding does not progress.

During the progress of the welding process, the slag 200 as described above is generated in the high-temperature region 230 in the state of the molten pool.

At this time, in the present invention, whether or not the slag 200 is fixed can be determined via the interval between the low-temperature region 220 and the slug 200.

More specifically, the high-temperature region 230 is a region in which the arc of FIG. 5 is located, and the temperature range thereof is, for example, 1200 to 1500° C.

Further, the slag 200 corresponds to a higher temperature than the high-temperature region and tends to exhibit a high temperature distribution, for example, about 200 to 400° C. higher than the high-temperature region.

In addition, the low-temperature region 220 is a region in which solidification proceeds after welding, and corresponds to a temperature lower than the temperature of the high-temperature region 230. For example, a region exhibiting a low temperature distribution of about 200 to 400° C. lower than the high-temperature region may be defined as a low-temperature region.

That is, in the present invention, when the slag is generated, a low-temperature region exhibiting a temperature distribution lower by about 200 to 400° C. than the temperature of the high-temperature region 230 is defined.

For example, depending on the setting, a region exhibiting a temperature lower by 200° C. than the temperature of the high-temperature region may be defined as a low-temperature region, and unlike this, a region exhibiting a temperature lower by 400° C. than the temperature of the high-temperature region may be defined as a low-temperature region.

The settings may be set variously depending on the type of welding base metal, the process temperature in the welding process, the type of wire used in the welding process, and the like.

In the present invention, a temperature difference between the slag and the low-temperature region can be set depending on the temperature range of the high-temperature region, the definition of the temperature region of the low-temperature region, and the temperature range of the slag.

For example, in the case where the temperature of the high-temperature region is 1200° C. and a region exhibiting a temperature lower than 200° C. than the temperature of the high-temperature region is defined as a low-temperature region depending on the setting, the low-temperature region may be defined as a region exhibiting the temperature of 1000° C. or less.

In this case, when the temperature of the slag is 1400° C., which is higher by 200° C. than the temperature of the high-temperature region, the temperature difference between the slag and the low-temperature region is set to 400° C., that is, the low-temperature region corresponds to a region having a temperature range lower than the temperature of the slag by 400° C. or more.

In the present invention, the temperature range of the low-temperature region is defined for the following reason. In the low-temperature region as described above, the molten pool has low fluidity, and the slag cannot move in the welding progress direction X, and the slag is fixed in a low-temperature range.

In other words, as will be described later, when the slag is located at a constant interval L1 from the low-temperature region, that is, when the slug maintains a sufficient interval from the low-temperature region, the slag can be continuously moved in the welding progress direction X along the molten pool in the high-temperature region.

However, in the case where the slag is located to be spaced apart from the low-temperature region by a certain interval L2, that is, when the slag is adjacent to the low-temperature region, the slag cannot move continuously in the welding progress direction X along the molten pool of the high-temperature region and the slag comes into contact with the low-temperature region, and the fixed slag is formed.

Therefore, in the present invention, determination whether or not the detected slag is fixed includes a step of defining a low-temperature region lower than the high-temperature region by a constant temperature, and thereafter, it is possible to check whether or not the fixed slag is generated through a step of determining whether or not the spaced interval between the low-temperature region and slag is equal to or less than a predetermined interval.

This will be described in more detail as follows.

First, referring to FIG. 7, the welding progress direction is the X direction, and the region A of the base material M includes a bead region 210, a low-temperature region 220, a high-temperature region 230, and a welding non-progress region 240. At this time, each region may correspond to the sizes of a1, a2, a3, and a4.

Subsequently, as the welding progresses, the region B of the base material M includes a bead region 210′, a low-temperature region 220′, a high-temperature region 230′, and a welding non-progress region 240′, and at this time, each region may correspond to the sizes of b1, b2, b3, and b4.

That is, the region a1 gradually increases to the size of b1, and the region a4 gradually decreases to the size of b4.

At this time, when the spaced interval between the slag 200 generated in the high-temperature region 230 and the low-temperature region 220 is L1, for example, when the spaced interval is sufficient, the slag can continuously move in the Y direction of FIG. 7, that is, the slag can continuously move in the welding progress direction X along the molten pool of the high-temperature region. Thus, the slag is not fixed.

Next, referring to FIG. 8, the welding progress direction is the X direction, and the region C of the base material M includes a bead region 310, a low-temperature region 320, a high-temperature region 330, and a welding non-progress region 340. At this time, each region may correspond to the sizes of c1, c2, c3, and c4.

Subsequently, as the welding progresses, the region D of the base material M includes a bead region 310′, a low-temperature region 320′, a high-temperature region 330′ and a welding non-progress region 340′. At this time, each region may correspond to the sizes of d1, d2, d3, and d4.

That is, the region c1 gradually increases to the size of d1, and the region c4 gradually decreases to the size of d 4.

At this time, when the spaced interval between the slag 300 generated in the high-temperature region 330 and the low-temperature region 320 is L2, for example, when the low-temperature region and the slag are located adjacent to each other, the slag cannot continuously move in the welding progress direction X along the molten pool of the high-temperature region, and comes into contact with the low-temperature region. Thus, the fixed slag is formed.

Of course, it is possible to check such fixed slag with the naked eye or to check the fixed position through the IR thermal camera.

However, as described above, in the case of the fixed type slag, the slag may be checked visually by an operator, but the slag may not be checked well visually by the operator. Accordingly, in the present invention, it can be said that it is of great significance to determine the position of the fixed type slag which is not checked visually.

That is, in the present invention, when the slag is generated, a low-temperature region lower than the high-temperature region by a constant temperature is defined, and thereafter, by determining whether or not the spaced interval between the low-temperature region and the slag is equal to or less than a predetermined interval, when the spaced interval between the low-temperature region and the slag is equal to or less than the predetermined interval, it is determined that the generated slag is fixed at that position.

Therefore, in the present invention, when it is determined that the detected slag is fixed, the position of the slug is analyzed and the coordinate value is calculated (S150).

On the other hand, when no slag is fixed, the welding part is continuously captured using the thermal imaging camera and the video signal is transmitted to the vision module (S120).

At this time, since the emitted infrared energy of the nonmetallic fixed type slag generally generated at the time of welding is lower than the molten pool which is metal, a principle of analyzing the position of the slag by the vision module 150 can detect whether or not slag is generated from the isothermal line of the temperature data measured via the IR thermal camera using such a temperature difference.

Finally, since the coordinate value calculated by analyzing the position of the slag corresponds to the position of the fixed slug, even if the fixed slag is not checked with the naked eye, the operator can check the position of the fixed slag which has not been checked with the naked eye through the calculated coordinate values.

Meanwhile, when defining a low-temperature region lower than the high-temperature region by a constant temperature and then determining whether or not the spaced interval between the low-temperature region and the slag is equal to or less than a predetermined interval, the constant temperature and the constant interval can input an appropriate value suitable for each welding.

In other words, such setting concerning the constant temperature and the constant interval can be variously set depending on the type of the welding base material, the process temperature in the welding process, the type of the wire used in the welding process, and the like.

As described above, in the present invention, when the slag is generated, a low-temperature region lower than the high-temperature region by a constant temperature is defined, and thereafter, it is determined whether or not the spaced interval between the low-temperature region and the slag is equal to or less than a predetermined interval.

As a result, when the spaced interval between the low-temperature region and the slag is equal to or less than the predetermined interval, it is possible to determine that the generated slag is fixed at that position.

Therefore, according to the present invention, even when the fixed slag is not checked with the naked eye, the operator can check the position of the fixed slag which is not checked with the naked eye, through the calculated coordinate value.

Embodiments of the present invention have been described with reference to the accompanying drawings above. However, those having ordinary knowledge in the technical field to which the present invention belongs will appreciate that the invention can be implemented in other concrete forms without changing the technical idea or essential features. It is therefore to be understood that the above-described embodiments are illustrative in all aspects and not restrictive.

### EXPLANATION OF REFERENCE NUMERALS

1 slag
100 welding device
110 welding power supply
120 wire feeder
122 gas container
125 wire
130 torch
140 camera
150 vision module

1. A MIG welding system comprising:
operating a vision module and a welding device;
capturing a thermal image of a welding part using an IR thermal camera connected to the vision module, converting the image into a video signal, and transmitting the video image to the vision module;
detecting whether there is slag through the vision module;
determining whether the detected slag is fixed when the slag is detected through the vision module; and
analyzing the position of the slag and calculating a coordinate value when it is determined that the detected slag is fixed.

2. The MIG welding system of claim 1, further comprising:
a base material M in which welding progresses,
wherein the base material M comprises a low-temperature region in which solidification of the molten pool progresses; and a high-temperature region which is located adjacent to the low-temperature region and in a state of a molten pool.

3. The MIG welding system of claim 2, wherein determining whether the detected slag is fixed comprises:
defining a low-temperature region lower than the high-temperature region by a constant temperature; and determining whether a spaced interval between the low-temperature region and the slag is equal to or less than a constant interval.

4. The MIG welding system of claim 3, wherein when the slag is not detected, the welding part is continuously captured through the IR thermal camera and a video signal is transmitted to the vision module.

5. The MIG welding system of claim 3, wherein in a case where the slag is not fixed, the welding part is continuously captured through the IR thermal camera and the video signal is transmitted to the vision module.
